(19) United States
(12) Patent Application Publication
(10) Pub. No.: US 2026/0346461 A1
(43) Pub. Date: Nov. 5, 2026

(54) MULTI-COUPLER CONNECTION DEVICE

(71) Applicant: HANYANG ENG CO., LTD., Hwaseong-si, Gyeonggi-do (KR)

(72) Inventors: Joo-In KIM, Hwaseong-si, Gyeonggi-do (KR); Chul-Hong LEE, Hwaseong-si, Gyeonggi-do (KR); Min-Woo LEE, Hwaseong-si, Gyeonggi-do (KR)

(73) Assignee: HANYANG ENG CO., LTD., Hwaseong-si, Gyeonggi-do (KR)

(21) Appl. No.: 19/485,596

(22) PCT Filed: Jun. 27, 2024
(86) PCT No.: PCT/KR2024/009038

§ 371 Date: Nov. 18, 2025

(30) Foreign Application Priority Data
Jun. 28, 2023 (KR) 10-2023-0083656
Aug. 1, 2023 (KR) 10-2023-0100445

(51) Int. Cl. B25J 9/16; B25J 5/02; B67D 7/02; B67D 7/34; B67D 7/78

(52) U.S. Cl. CPC B25J 9/1697; B25J 5/02; B25J 9/1661; B67D 7/0288; B67D 7/346; B67D 7/78

(57) ABSTRACT

A multi coupler connection device for connecting a supply-side coupler of a supply hose brought into an interior of any one of a plurality of door units corresponding to each of a plurality of storage units each storing different chemicals with a storage-side coupler of any one of the plurality of storage units, includes: an articulated robot that moves and connects the supply-side coupler with the storage-side coupler; a main stage unit that transfers the articulated robot in a direction in which the plurality of storage units are disposed; and a vision unit that captures images to measure a position of the supply-side coupler and/or the storage-side coupler.

### CROSS-REFERENCE TO PRIOR APPLICATIONS

This Application is a National Stage Patent Application of PCT International Application No. PCT/KR2024/009038 (filed on Jun. 27, 2024), which claims priority to Korean Patent Application Nos. 10-2023-0083656 (filed on Jun. 28, 2023) and 10-2023-0100445 (filed on Aug. 1, 2023), which are all hereby incorporated by reference in their entirety.

### BACKGROUND

The present invention relates to a multi coupler connection device, and more particularly, to a multi coupler connection device for connecting various types of supply hoses used for supplying different chemicals to a chemical storage unit that stores a corresponding chemical among a plurality of chemical storage units.

Generally, in chemical usage sites that use various chemicals, such as semiconductor factories or chemical factories, a chemical storage unit including a storage tank is provided.

Recently, in the process of supplying chemicals from a tank lorry carrying chemicals to a chemical storage facility through a supply hose, a so-called Automatic Clean Quick Coupler (ACQC) system has been used to automatically connect a coupler of the supply hose and a coupler of the chemical storage unit in order to protect workers from the harmfulness or danger of chemicals and to improve work efficiency.

A conventional automatic clean quick coupler system is provided for each type of chemical as shown in Korean Patent Publication No. 10-2023-0050169. In this case, a coupler connection device including a guide rail, a drive unit rail, and a drive unit for connecting the coupler of the supply hose to a corresponding connector is provided for each type of chemical. Accordingly, there has been a problem that the investment cost for automation is excessively increased.

### SUMMARY

The problem to be solved by the present invention is to provide a multi coupler connection device capable of automatically connecting couplers of various types of supply hoses.

The problems of the present invention are not limited to the problems mentioned above, and other problems not mentioned will be clearly understood by those skilled in the art from the following description.

To achieve the above object, a multi coupler connection device according to an embodiment of the present invention for connecting a supply-side coupler of a supply hose brought into an interior of any one of a plurality of door units corresponding to each of a plurality of storage units each storing different chemicals with a storage-side coupler of any one of the plurality of storage units comprises: an articulated robot that moves and connects the supply-side coupler with the storage-side coupler; a main stage unit that transfers the articulated robot in a direction in which the plurality of storage units are disposed; and a vision unit that captures images to measure a position of the supply-side coupler and/or the storage-side coupler.

To achieve the above object, a multi coupler connection device according to an embodiment of the present invention comprises: an articulated robot that moves and connects the supply-side coupler with the storage-side coupler; a main stage unit that transfers the articulated robot in a direction in which the plurality of storage units are disposed; and a vision unit for determining whether the supply-side coupler should be connected to the storage-side coupler.

Specific details of other embodiments are included in the detailed description and drawings.

According to the multi coupler connection device of the present invention, there are one or more of the following effects.

First, there is an advantage that coupler connection can be automated at low cost by connecting couplers of various supply hoses with a single coupler connection device.

Second, there is an advantage that couplers of various types of supply hoses can be connected using an articulated robot.

Third, there is an advantage that the articulated robot can be transferred stably and accurately using appropriate mechanical elements for transferring the articulated robot.

Fourth, there is an advantage that the articulated robot can accurately grip the coupler using the vision unit and precisely couple with the corresponding coupler after movement.

Fifth, there is an advantage that misfeeding of chemicals is prevented by recognizing the supply-side coupler to be connected with the storage-side coupler using the vision unit.

The effects of the present invention are not limited to the effects mentioned above, and other effects not mentioned will be clearly understood by those skilled in the art from the description of the claims.

### BRIEF DESCRIPTION OF THE DRAWINGS

FIG. 1 is a perspective view of a multi automatic clean quick coupler system according to an embodiment of the present invention.

FIG. 2 is a plan view of a multi automatic clean quick coupler system according to an embodiment of the present invention.

FIG. 3 is a side view of a multi automatic clean quick coupler system according to an embodiment of the present invention.

FIG. 4 is a perspective view of a multi coupler connection device according to an embodiment of the present invention.

FIG. 5 is an exploded perspective view of a multi coupler connection device according to an embodiment of the present invention.

FIG. 6 is a partial perspective view of a multi coupler connection device according to an embodiment of the present invention.

FIG. 7 is a partial exploded perspective view of a first main stage linear module of a multi coupler connection device according to an embodiment of the present invention.

FIG. 8 is a partial exploded perspective view of a main stage drive module of a multi coupler connection device according to an embodiment of the present invention.

FIGS. 9 to 11 are operation example diagrams of a multi coupler connection device according to an embodiment of the present invention.

### DETAILED DESCRIPTION

The advantages and features of the present invention and methods for achieving them will become clear by referring to the embodiments described in detail below together with the accompanying drawings. However, the present invention is not limited to the embodiments disclosed below but may be implemented in various different forms, and these embodiments are provided only to make the disclosure of the present invention complete and to fully inform those skilled in the art to which the present invention pertains of the scope of the invention, and the present invention is only defined by the scope of the claims. Like reference numerals refer to like elements throughout the specification.

Although first, second, etc. are used to describe various components, it goes without saying that these components are not limited by these terms. These terms are only used to distinguish one component from another, and unless specifically stated to the contrary, a first component may be a second component.

Throughout the specification, unless specifically stated to the contrary, each component may be singular or plural.

Hereinafter, that an arbitrary configuration is disposed “on the top (or bottom)” of a component or “on (or under)” a component may mean not only that the arbitrary configuration is disposed in contact with the top surface (or bottom surface) of the component, but also that another configuration may be interposed between the component and the arbitrary configuration disposed on (or under) the component.

Also, when a component is described as being “connected,” “coupled,” or “connected” to another component, it should be understood that the components may be directly connected or connected to each other, but another component may be “interposed” between each component, or each component may be “connected,” “coupled,” or “connected” through another component.

As used in this specification, the singular forms include plural forms unless the context clearly indicates otherwise. In this application, terms such as “comprises” or “includes” should not be construed as necessarily including all of the various components or various steps described in the specification, and it should be construed that some components or some steps may not be included, or additional components or steps may be further included.

Throughout the specification, “A and/or B” means A, B, or A and B unless specifically stated to the contrary, and “C to D” means C or more and D or less unless specifically stated to the contrary.

Hereinafter, the present invention will be described with reference to drawings for explaining a multi coupler connection device according to embodiments of the present invention.

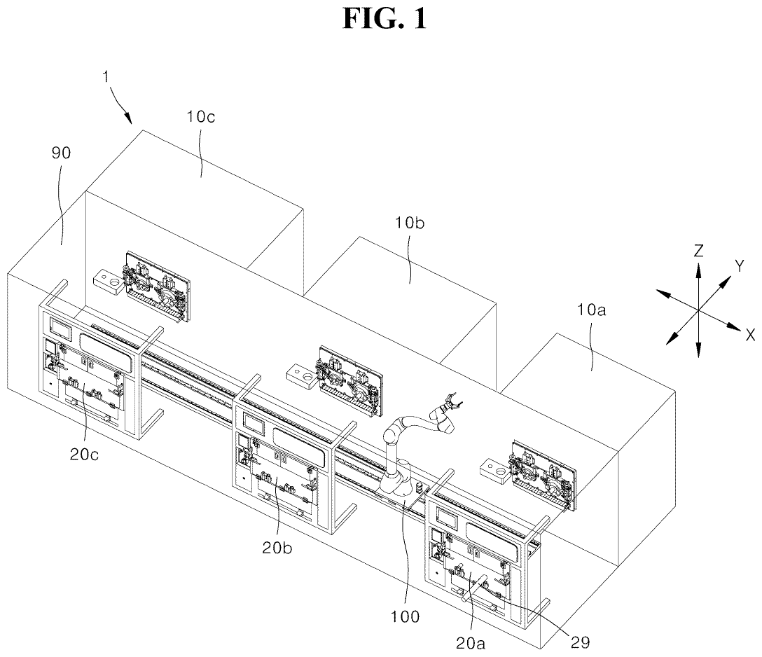

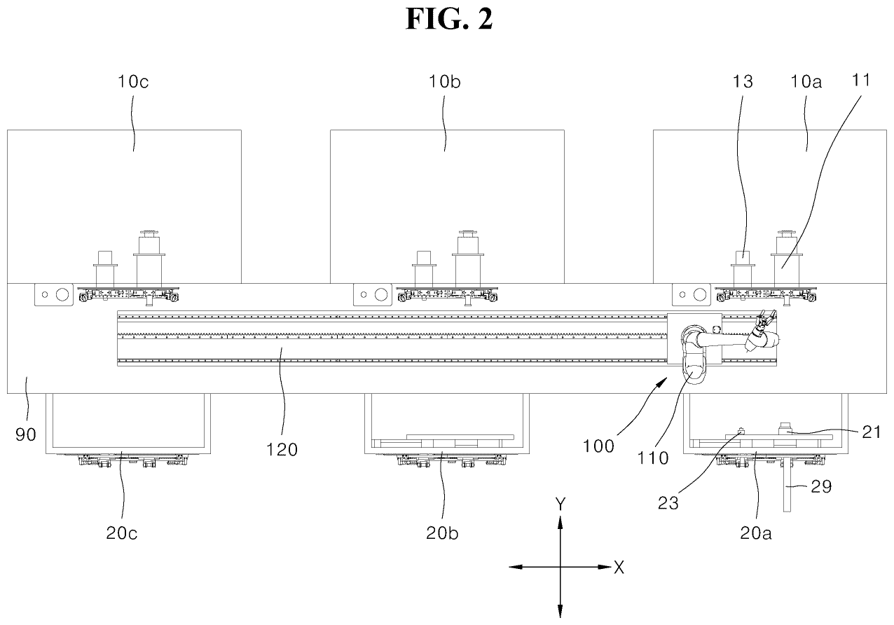

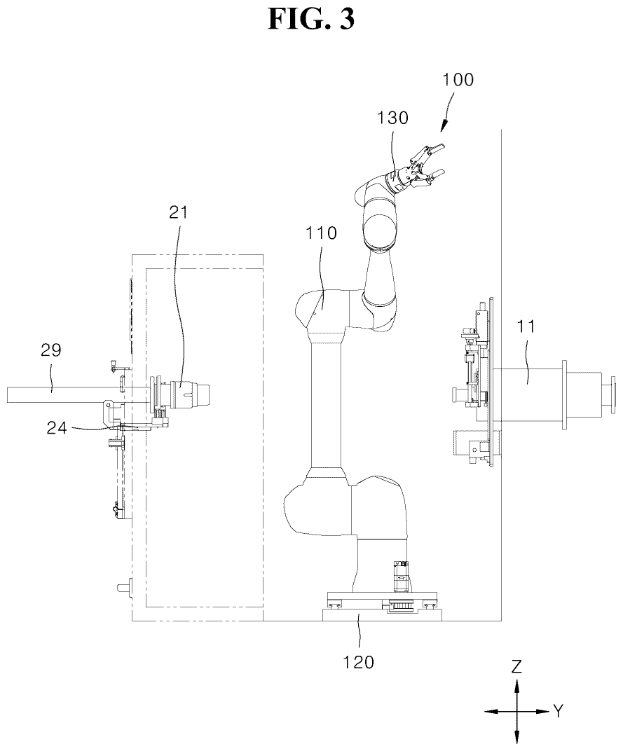

FIG. 1 is a perspective view of a multi automatic clean quick coupler system according to an embodiment of the present invention, FIG. 2 is a plan view of a multi automatic clean quick coupler system according to an embodiment of the present invention, and FIG. 3 is a side view of a multi automatic clean quick coupler system according to an embodiment of the present invention. A multi automatic clean quick coupler system 1 according to an embodiment of the present invention includes: a plurality of storage units 10a, 10b, 10c each storing different chemicals; a plurality of door units 20a, 20b, 20c disposed corresponding to each of the plurality of storage units 10a, 10b, 10c and into which a supply hose 29 of a tank lorry is brought; a supply-side coupler 21 provided at an end of the supply hose 29; a coupler holder 24 for holding the supply-side coupler 21; a storage-side coupler 11 provided in each of the plurality of storage units 10a, 10b, 10c and connected to the supply-side coupler 21; a multi coupler connection device 100 that is brought into the interior of any one of the plurality of door units 20a, 20b, 20c and connects the supply-side coupler 21 held on the coupler holder 24 with the storage-side coupler 11 of any one of the plurality of storage units 10a, 10b, 10c; and a shielding booth 90 that forms a space where the supply-side coupler 21 is connected to the storage-side coupler 11.

The plurality of storage units 10a, 10b, 10c each store various types of chemicals. Each of the plurality of storage units 10a, 10b, 10c includes a storage tank (not shown) that stores chemicals used in semiconductor factories or chemical factories. The plurality of storage units 10a, 10b, 10c are disposed spaced apart in one direction (x direction). In this embodiment, three of the plurality of storage units 10a, 10b, 10c are provided, and include a first storage unit 10a that stores a first chemical, a second storage unit 10b that stores a second chemical, and a third storage unit 10c that stores a third chemical.

Each of the plurality of storage units 10a, 10b, 10c is provided with a storage-side coupler 11 to which the supply-side coupler 21 is connected, and a storage-side nitrogen coupler 13 to which nitrogen is supplied.

Each of the plurality of storage-side couplers 11 is disposed in each of the plurality of storage units 10a, 10b, 10c and is connected to the supply-side coupler 21 of the supply hose 29 connected to the tank lorry so that the chemical stored in the tank lorry is stored in the storage tank. Each of the plurality of storage-side couplers 11 must be connected to the supply-side coupler 21 of the tank lorry in which the corresponding chemical is stored so that a specific chemical among various types of chemicals can be stored in the storage tank. Each of the plurality of storage-side couplers 11 is connected to the supply-side coupler 21 by the multi coupler connection device 100.

Each of the plurality of storage-side nitrogen couplers 13 is disposed in each of the plurality of storage units 10a, 10b, 10c and is connected to the supply-side nitrogen coupler 23 connected to the tank lorry so that nitrogen stored in the nitrogen storage tank is stored in the tank lorry. Each of the plurality of storage-side nitrogen couplers 13 is connected to the supply-side nitrogen coupler 23 by the multi coupler connection device 100.

The plurality of storage-side couplers 11 and the plurality of storage-side nitrogen couplers 13 are disposed in pairs in each of the plurality of storage units 10a, 10b, 10c. After the storage-side coupler 11 and the storage-side nitrogen coupler 13 of any one storage unit 10a, 10b, 10c among the plurality of storage units 10a, 10b, 10c are connected to the supply-side coupler 21 and the supply-side nitrogen coupler 23 by the multi coupler connection device 100, nitrogen is supplied from the nitrogen storage tank to the tank lorry and the chemical stored in the tank lorry is stored in the storage tank.

Hereinafter, the multi coupler connection device 100 will be described as connecting the supply-side coupler 21 to the storage-side coupler 11, and the same description also applies to the multi coupler connection device 100 connecting the supply-side nitrogen coupler 23 to the storage-side nitrogen coupler 13.

Each of the plurality of door units 20a, 20b, 20c is opened and closed so that the supply-side coupler 21 and the supply-side nitrogen coupler 23 of the tank lorry can be brought into the shielding booth 90. The plurality of door units 20a, 20b, 20c are disposed spaced apart in a direction (x direction) in which the plurality of storage units 10a, 10b, 10c are disposed. Each of the plurality of door units 20a, 20b, 20c is disposed spaced apart in a direction (y direction) orthogonal to the x direction in correspondence with each of the plurality of storage units 10a, 10b, 10c. In this embodiment, three of the plurality of door units 20a, 20b, 20c are provided, and include a first door unit 20a disposed corresponding to the first storage unit 10a, a second door unit 20b disposed corresponding to the second storage unit 10b, and a third door unit 20c disposed corresponding to the third storage unit 10c.

It is preferable that the plurality of door units 20a, 20b, 20c are not opened simultaneously, and only any one door unit 20a, 20b, 20c is opened so that only the supply-side coupler 21 and the supply-side nitrogen coupler 23 of the tank lorry are brought into the shielding booth 90.

The supply-side coupler 21 is provided at an end of the supply hose 29 of the tank lorry. The supply-side coupler 21 brought into the shielding booth 90 through any one of the plurality of door units 20a, 20b, 20c is held on the coupler holder 24 and then moved by the multi coupler connection device 100 to be connected to the storage-side coupler 11.

The supply-side nitrogen coupler 23 is provided at an end of a nitrogen hose (not shown) of the tank lorry. The supply-side nitrogen coupler 23 brought into the shielding booth 90 through any one of the plurality of door units 20a, 20b, 20c is held on a nitrogen coupler holder (not shown) and then moved by the multi coupler connection device 100 to be connected to the storage-side nitrogen coupler 13.

The multi coupler connection device 100 is disposed between the plurality of storage units 10a, 10b, 10c and the plurality of door units 20a, 20b, 20c. The multi coupler connection device 100 is configured so that the supply-side coupler 21 can be connected to the corresponding storage-side coupler 11 regardless of which of the plurality of door units 20a, 20b, 20c the supply-side coupler 21 is brought in through.

The multi coupler connection device 100 includes: an articulated robot 110 that moves and connects the supply-side coupler 21 with the storage-side coupler; a main stage unit 120 that transfers the articulated robot 110 in a direction (x direction) in which the plurality of storage units 10a, 10b, 10c are disposed; and a vision unit 130 that is provided on the articulated robot 110 and captures images to measure a position of the supply-side coupler 21 and/or the storage-side coupler 11.

The articulated robot 110 grips the supply-side coupler 21 held on the coupler holder 24 and moves the supply-side coupler 21. The articulated robot 110 moves and connects the supply-side coupler 21 with the storage-side coupler 11. It is preferable that the articulated robot 110 is a vertical articulated robot with 6 degrees of freedom or 7 degrees of freedom. The articulated robot 110 is transferred by the main stage unit 120 in a direction (x direction) in which the plurality of storage units 10a, 10b, 10c (or the plurality of door units 20a, 20b, 20c) are disposed so that the distance from the supply-side coupler 21 held on the coupler holder 24 to the storage-side coupler 11 falls within the operating range. The articulated robot 110 is controlled by a direct teaching method, and images captured by the vision unit 130 can be utilized for accurate position detection. The main stage unit 120 supports the articulated robot 110 and transfers the articulated robot 110 in a direction (x direction) in which the plurality of storage units 10a, 10b, 10c (or the plurality of door units 20a, 20b, 20c) are disposed. The main stage unit 120 transfers the articulated robot 110 to the door unit 20a, 20b, 20c that is opened and into which the supply-side coupler 21 is brought among the plurality of door units 20a, 20b, 20c. The main stage unit 120 is disposed between the plurality of storage units 10a, 10b, 10c and the plurality of door units 20a, 20b, 20c. The vision unit 130 captures images to measure positions of the supply-side coupler 21, the storage-side coupler 11, and/or the articulated robot 110. It is preferable that the vision unit 130 is provided on the articulated robot 110. The vision unit 130 includes an imaging element such as a Charge-Coupled Device (CCD) or a Complementary metal-oxide-semiconductor (CMOS) to convert an image into an electrical signal.

The vision unit 130 captures images of a barcode or QR code (Quick Response code) attached to the supply-side coupler 21 and/or the storage-side coupler 11 to measure the position of the supply-side coupler 21 and/or the storage-side coupler 11. The vision unit 130 captures images of the barcode or QR code attached to the supply-side coupler 21 and the storage-side coupler 11 to recognize (confirm) the storage-side coupler 11 to be connected to the supply-side coupler 21.

It is preferable that the vision unit 130 captures images of a hole into which the chemical of the storage-side coupler 11 flows or a hole into which the storage-side coupler 11 is inserted to measure the exact position of the storage-side coupler 11 to be connected to the supply-side coupler 21.

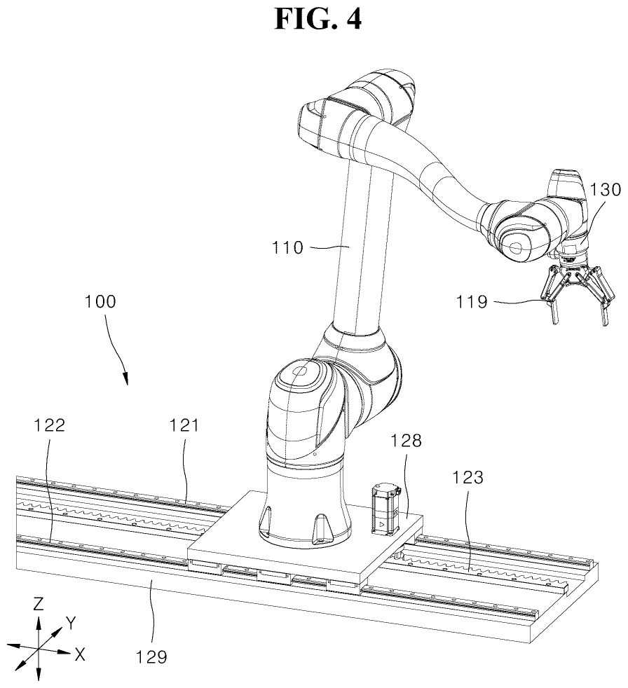

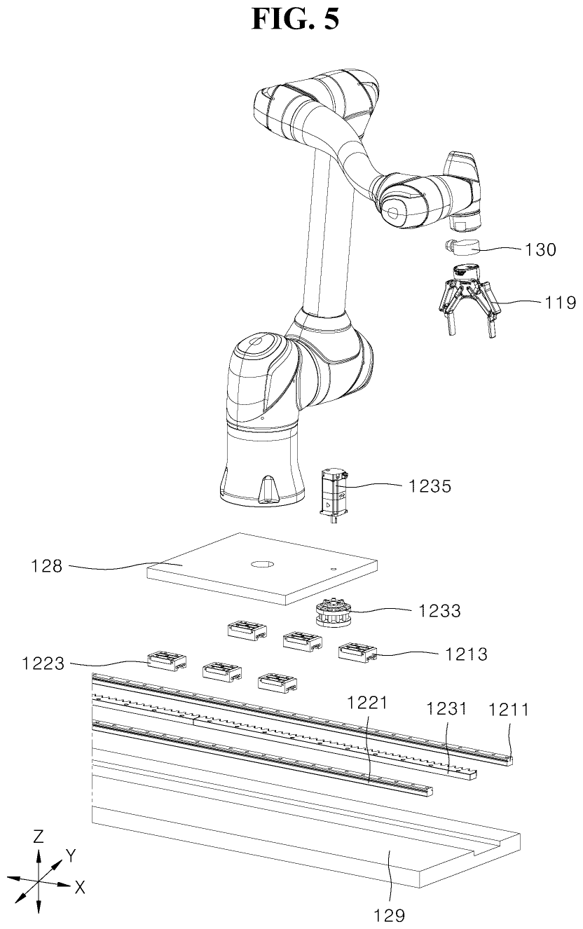

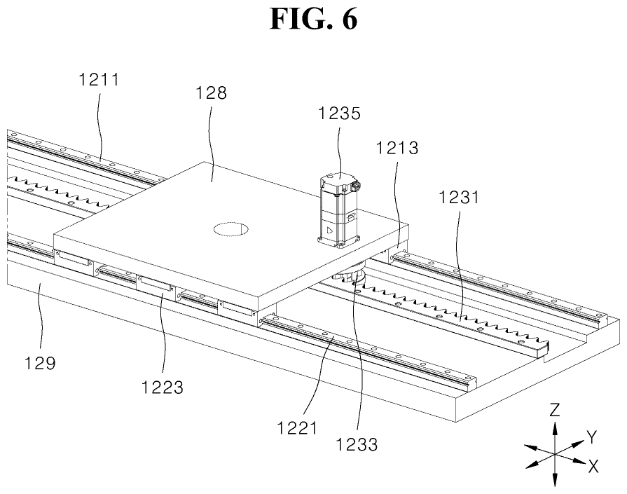

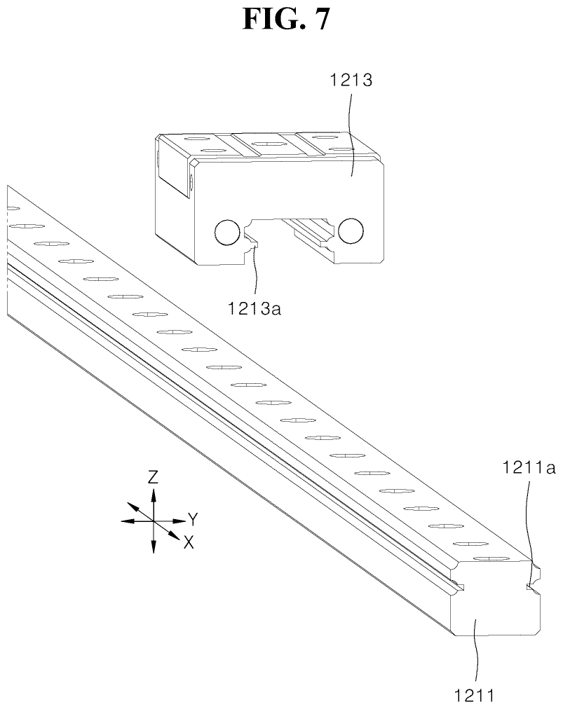

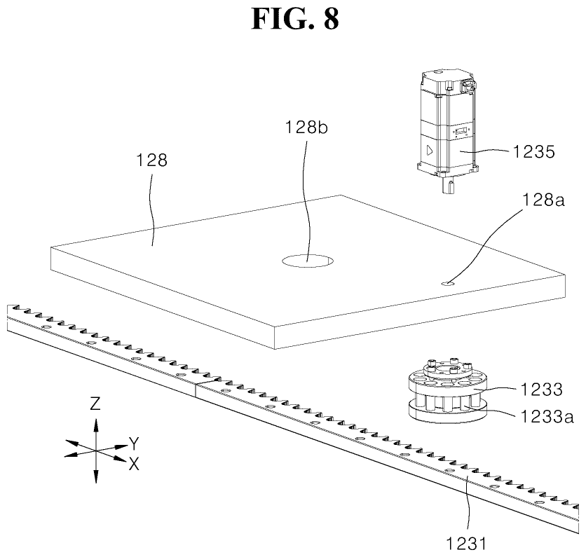

FIG. 4 is a perspective view of a multi coupler connection device according to an embodiment of the present invention, FIG. 5 is an exploded perspective view of a multi coupler connection device according to an embodiment of the present invention, FIG. 6 is a partial perspective view of a multi coupler connection device according to an embodiment of the present invention, FIG. 7 is a partial exploded perspective view of a first main stage linear module of a multi coupler connection device according to an embodiment of the present invention, and FIG. 8 is a partial exploded perspective view of a main stage drive module of a multi coupler connection device according to an embodiment of the present invention.

Referring to FIGS. 4 and 5, the articulated robot 110 includes a gripper 119 that grips the supply-side coupler 21, and the vision unit 130 is disposed adjacent to the gripper 119. The vision unit 130 is disposed adjacent to the gripper 119 so that the position of the target object to be gripped by the gripper 119 can be measured relatively accurately from the captured image, and the vision unit 130 has a high degree of freedom so that the vision unit 130 can capture images in various postures and positions.

Referring to FIG. 4, the main stage unit 120 includes: a main stage base 129; a robot base 128 provided on an upper side of the main stage base 129 and supporting the articulated robot 110; a plurality of main stage linear modules 121, 122 that connect the robot base 128 and the main stage base 129 to slide linearly (x direction) relative to each other; and a main stage drive module 123 disposed between the plurality of main stage linear modules 121, 122 and moving the robot base 128 linearly (x direction).

The main stage base 129 is fixedly disposed on the floor of the shielding booth 90 of the multi automatic clean quick coupler system 1. The main stage base 129 has a long plate shape, and is disposed between the plurality of storage units 10a, 10b, 10c and the plurality of door units 20a, 20b, 20c with a direction (x direction) in which the plurality of storage units 10a, 10b, 10c (or the plurality of door units 20a, 20b, 20c) are disposed as a length direction.

The plurality of main stage linear modules 121, 122, the main stage drive module 123, and the robot base 128 are disposed on the main stage base 129.

The robot base 128 supports the articulated robot 110 and moves linearly (x direction) on the main stage base 129 to transfer the articulated robot 110 in the x direction. The robot base 128 is coupled to slide with the main stage base 129 by the plurality of main stage linear modules 121, 122, and is moved linearly (x direction) by the main stage drive module 123.

The plurality of main stage linear modules 121, 122 guide the robot base 128 in the x direction so that the heavy articulated robot 110 can be transferred. The plurality of main stage linear modules 121, 122 connect the robot base 128 and the main stage base 129 so that the frictional force of the robot base 128 is minimized.

The plurality of main stage linear modules 121, 122 stably support the robot base 128 so that the articulated robot 110 does not fall over during operation or transfer.

In this embodiment, the plurality of main stage linear modules 121, 122 include: a first main stage linear module 121 disposed at one end (one end in a direction (y direction) orthogonal to the transfer direction of the articulated robot 110) of the robot base 128; and a second main stage linear module 122 disposed at the other end (the other end in a direction (y direction) orthogonal to the transfer direction of the articulated robot 110) of the robot base 128. Since the articulated robot 110 has a large change in the center of gravity when connecting the supply-side coupler 21 with the storage-side coupler 11, it is preferable that the first main stage linear module 121 and the second main stage linear module 122 are disposed as far apart as possible in a direction (y direction) in which the supply-side coupler 21 is connected with the storage-side coupler 11.

Referring to FIGS. 5 and 6, each of the plurality of main stage linear modules 121, 122 includes: a main stage rail 1211, 1221 coupled to the main stage base 129 and disposed with the transfer direction (x direction) of the articulated robot 110 as a length direction; and a main stage block 1213, 1223 coupled to slide with the main stage rail 1211, 1221 and coupled to the robot base 128.

In this embodiment, the first main stage linear module 121 includes a first main stage rail 1211 and a first main stage block 1213, and the second main stage linear module 122 includes a second main stage rail 1221 and a second main stage block 1223. Since the first main stage linear module 122 has the same shape and function as the second main stage linear module 122 and differs only in arrangement, the following description will be based on the first main stage linear module 121.

The main stage rails 1211, 1221 have a long rail shape and are coupled to the upper side of the main stage base 129 with the transfer direction (x direction) of the articulated robot 110 as a length direction. A plurality of the main stage rails 1211, 1221 are provided, and the plurality of main stage rails 1211, 1221 are disposed spaced apart in the y direction. A main stage rack 1231 to be described later is disposed between the plurality of main stage rails 1211, 1221. In this embodiment, the first main stage rail 1211 and the second main stage rail 1221 are disposed spaced apart in the y direction with the main stage rack 1231 therebetween.

The main stage blocks 1213, 1223 are coupled to the lower side of the robot base 128. The main stage blocks 1213, 1223 serve as sliding bearings coupled to slide on the main stage rails 1211, 1221. A plurality of the main stage blocks 1213, 1223 are provided, and the plurality of main stage blocks 1213, 1223 are disposed spaced apart at one end or the other end (one end or the other end in a direction (y direction) orthogonal to the transfer direction of the articulated robot 110) of the robot base 128. In this embodiment, the plurality of first main stage blocks 1213 are disposed spaced apart at one end of the robot base 128, and the plurality of second main stage blocks 1223 are disposed spaced apart at the other end of the robot base 128.

Referring to FIG. 7, the main stage rails 1211, 1221 have main stage rail grooves 1211a formed on sides thereof and recessed in a direction (y direction) orthogonal to the transfer direction of the articulated robot 110 (a direction in which the supply-side coupler 21 is connected with the storage-side coupler 11), and the main stage blocks 1213, 1223 have main stage block protrusions 1213a formed on sides thereof, protruding in a direction (y direction) orthogonal to the transfer direction of the articulated robot 110 (a direction in which the supply-side coupler 21 is connected with the storage-side coupler 11), and inserted into the main stage rail grooves 1211a.

Since the articulated robot 110 has a large change in the center of gravity when connecting the supply-side coupler 21 with the storage-side coupler 11, the main stage rail grooves 1211a and the main stage block protrusions 1213a are formed in a direction (y direction) in which the supply-side coupler 21 is connected with the storage-side coupler 11 to minimize the occurrence of play.

Referring to FIG. 8, the main stage drive module 123 includes: a main stage motor 1235 provided on the upper side of the robot base 128 and providing rotational force; a main stage pinion 1233 coupled to the lower side of the robot base 128 and rotated by the main stage motor 1235; and a main stage rack 1231 coupled to the upper side of the main stage base 129 and engaged with the main stage pinion 1233.

The main stage motor 1235 generates rotational force to rotate the main stage pinion 1233. It is preferable that the main stage motor 1235 is a servomotor with controllable rotation speed. The main stage motor 1235 is provided on the upper side of the robot base 128, and a rotation shaft penetrates the robot base 128 and is connected to the main stage pinion 1233. The rotation shaft of the main stage motor 1235 passes through a rotation shaft insertion hole 128a of the robot base 128. The robot base 128 has a robot connection hole 128b to which the articulated robot 110 is connected formed at the center, and the rotation shaft insertion hole 128a is formed at the periphery.

The main stage pinion 1233 is rotated by the main stage motor 1235, is engaged with the main stage pinion 1233, and is moved in the x direction. The main stage pinion 1233 converts rotational force by the main stage motor 1235 into linear motion force.

The main stage pinion 1233 includes a plurality of pinion roller pins 1233a so that the main stage pinion 1233 can transfer the heavy articulated robot 110 and has less backlash. Each of the plurality of pinion roller pins 1233a is freely rotatable. The plurality of pinion roller pins 1233a are disposed annularly spaced apart around the rotation axis of the main stage pinion 1233. At least two or more of the plurality of pinion roller pins 1233a are in contact with the teeth of the main stage rack 1231.

The main stage rack 1231 has a long bar shape and teeth on one side with which the main stage pinion 1233 is engaged. The main stage rack 1231 is engaged with the main stage pinion 1233 to convert the rotational motion of the main stage pinion 1233 into linear motion. The main stage rack 1231 has trochoid-type teeth formed thereon to contact at least two or more of the plurality of pinion roller pins 1233a.

The main stage rack 1231 is disposed below the robot connection hole 128b at the center of the robot base 128. The main stage rack 1231 is disposed between the plurality of main stage rails 1211, 1221. The main stage rack 1231 is disposed parallel to the plurality of main stage rails 1211, 1221.

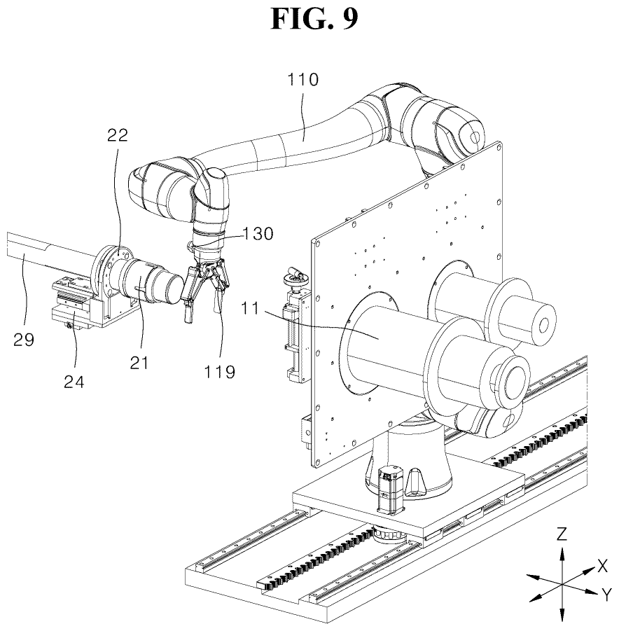

FIGS. 9 to 11 are operation example diagrams of a multi coupler connection device according to an embodiment of the present invention.

Hereinafter, the operation of the multi coupler connection device according to an embodiment of the present invention will be described.

A tank lorry carrying a specific chemical stops in front of the door unit 20a, 20b, 20c corresponding to the storage unit 10a, 10b, 10c in which the corresponding chemical is stored among the plurality of door units 20a, 20b, 20c. After the door unit 20a, 20b, 20c is opened and the supply hose 29 and supply-side coupler 21 of the tank lorry are brought into the shielding booth 90, the supply-side coupler 21 and supply hose 29 are held on the coupler holder 24. When the main stage motor 1235 of the main stage unit 120 generates rotational force, the robot base 128 moves linearly in the x direction to transfer the articulated robot 110 to the door unit 20a, 20b, 20c side into which the supply-side coupler 21 has been brought (the storage unit 10a, 10b, 10c side where the specific chemical is to be stored).

When the transfer of the articulated robot 110 is completed, the articulated robot 110 operates so that the vision unit 130 can capture images of the supply-side code 22 attached to the supply-side coupler 21 as shown in FIG. 9. The supply-side code 22 is a barcode, QR code, or other marker. The vision unit 130 captures images of the supply-side code 22 to measure the position of the supply-side coupler 21 and recognize the type of the supply-side coupler 21.

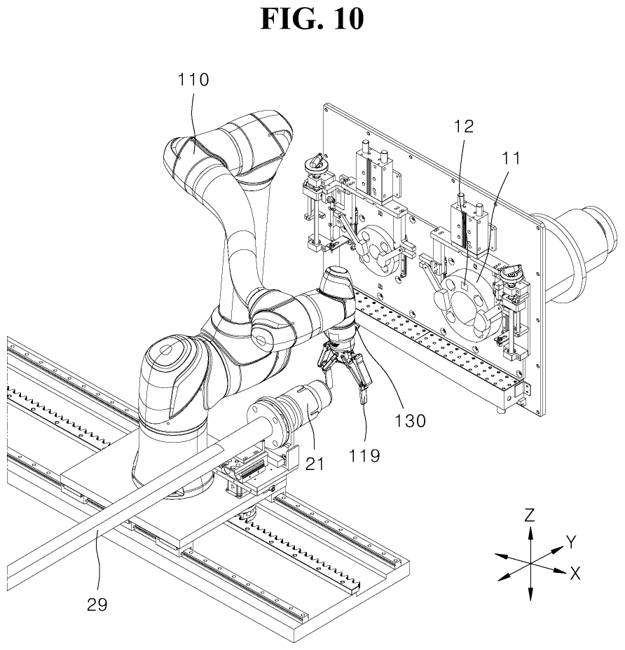

After capturing images of the supply-side code 22, the articulated robot 110 operates so that the vision unit 130 can capture images of the storage-side code 12 attached to the storage-side coupler 11 as shown in FIG. 10. The storage-side code 12 is a barcode, QR code, or other marker. The vision unit 130 captures images of the storage-side code 12 to measure the position of the storage-side coupler 11 and recognize the type of the storage-side coupler 11.

Through the supply-side code 22 and the storage-side code 12 captured by the vision unit 130, whether the supply-side coupler 21 should be connected to the storage-side coupler 11 is confirmed. This can prevent a specific chemical of the tank lorry from being supplied to a storage unit 10a, 10b, 10c where a different chemical is to be stored.

According to embodiments, the vision unit 130 may capture images of the hole into which the chemical of the storage-side coupler 11 flows and/or the hole into which the supply-side coupler 21 is inserted. Accordingly, the articulated robot 110 is accurately controlled so that the supply-side coupler 21 can be aligned with the storage-side coupler 11.

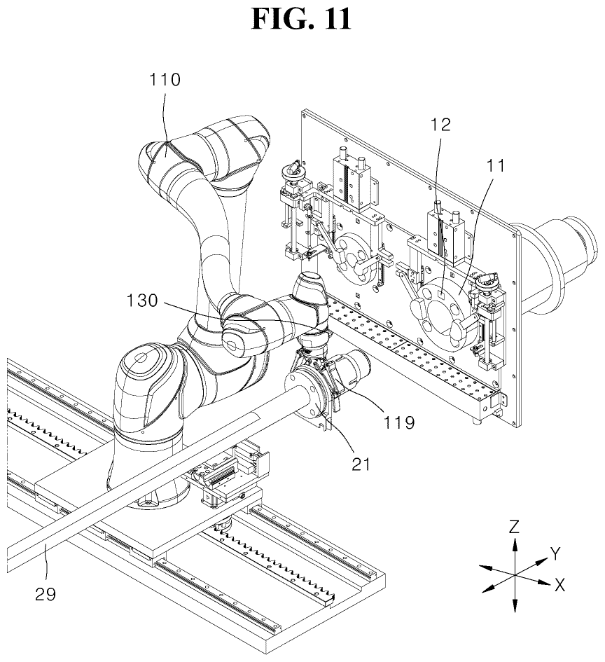

When recognition of the supply-side code 22 and the storage-side code 12 is completed, the articulated robot 110 grips the supply-side coupler 21 held on the coupler holder 24 with the gripper 119. After separating the supply-side coupler 21 from the coupler holder 24, the articulated robot 110 moves the supply-side coupler 21 in the y direction and couples the supply-side coupler 21 to the storage-side coupler 11 as shown in FIG. 11.

Through the above-described process, the articulated robot 110 couples the supply-side nitrogen coupler 23 to the storage-side nitrogen coupler 13. When the couplers are fastened, nitrogen is supplied to the tank lorry and the chemical stored in the tank lorry is supplied to the storage tank of the storage unit 10a, 10b, 10c.

After the supply of the chemical is completed, the articulated robot 110 separates the supply-side coupler 21 from the storage-side coupler 11, moves the supply-side coupler 21, and places the supply-side coupler 21 on the coupler holder 24.

While the preferred embodiments of the present invention have been shown and described above, the present invention is not limited to the specific embodiments described above, and various modifications may be made by those skilled in the art to which the invention pertains without departing from the gist of the invention as claimed in the claims, and these modifications should not be individually understood apart from the technical spirit or perspective of the present invention.

1. A multi coupler connection device for connecting a supply-side coupler of a supply hose brought into an interior of any one of a plurality of door units corresponding to each of a plurality of storage units each storing different chemicals with a storage-side coupler of any one of the plurality of storage units, the device comprising:
an articulated robot that moves and connects the supply-side coupler with the storage-side coupler;
a main stage unit that transfers the articulated robot in a direction in which the plurality of storage units are disposed; and
a vision unit that captures images to measure a position of the supply-side coupler and/or the storage-side coupler.

2. The multi coupler connection device of claim 1, wherein the articulated robot comprises a gripper that grips the supply-side coupler, and
the vision unit is disposed adjacent to the gripper.

3. The multi coupler connection device of claim 1, wherein the vision unit captures images of a storage-side code attached to the storage-side coupler to measure the position of the storage-side coupler.

4. The multi coupler connection device of claim 1, wherein the vision unit captures images of a hole into which the chemical of the storage-side coupler flows to measure the position of the storage-side coupler.

5. The multi coupler connection device of claim 1, wherein the vision unit captures images of a supply-side code attached to the supply-side coupler to measure the position of the storage-side coupler.

6. The multi coupler connection device of claim 1, wherein the vision unit captures images of a storage-side code attached to the storage-side coupler and a supply-side code attached to the supply-side coupler to recognize the storage-side coupler to be connected to the supply-side coupler.

7. The multi coupler connection device of claim 1, wherein the main stage unit comprises:
a main stage base;
a robot base provided on an upper side of the main stage base and supporting the articulated robot;
a plurality of main stage linear modules that connect the robot base and the main stage base to slide linearly relative to each other; and
a main stage drive module disposed between the plurality of main stage linear modules and moving the robot base linearly.

8. The multi coupler connection device of claim 7, wherein each of the plurality of main stage linear modules comprises:
a main stage rail coupled to the main stage base and disposed with a transfer direction of the articulated robot as a length direction; and
a main stage block coupled to slide with the main stage rail and coupled to the robot base.

9. The multi coupler connection device of claim 8, wherein the main stage rail has a main stage rail groove formed on a side thereof and recessed in a direction orthogonal to the transfer direction of the articulated robot, and
the main stage block has a main stage block protrusion formed on a side thereof, protruding in a direction orthogonal to the transfer direction of the articulated robot, and inserted into the main stage rail groove.

10. The multi coupler connection device of claim 8, wherein the main stage block is disposed at one end of the robot base in a direction orthogonal to the transfer direction of the articulated robot.

11. The multi coupler connection device of claim 10, wherein a plurality of the main stage blocks are provided, and
the plurality of main stage blocks are disposed spaced apart at the one end of the robot base.

12. The multi coupler connection device of claim 7, wherein the plurality of main stage linear modules comprise:
a first main stage linear module disposed at one end of the robot base in a direction orthogonal to the transfer direction of the articulated robot; and
a second main stage linear module disposed at the other end of the robot base in a direction orthogonal to the transfer direction of the articulated robot.

13. The multi coupler connection device of claim 7, wherein the main stage drive module comprises:
a main stage motor provided on an upper side of the robot base and providing rotational force;
a main stage pinion coupled to a lower side of the robot base and rotated by the main stage motor; and
a main stage rack coupled to an upper side of the main stage base and engaged with the main stage pinion.

14. The multi coupler connection device of claim 13, wherein the main stage pinion comprises a plurality of pinion roller pins disposed annularly spaced apart and each being rotatable, and
the main stage rack has trochoid-type teeth formed thereon and contacts at least two or more of the plurality of pinion roller pins.

15. The multi coupler connection device of claim 13, wherein the main stage motor has a rotation shaft that penetrates the robot base and is connected to the main stage pinion.

16. The multi coupler connection device of claim 13, wherein the plurality of main stage linear modules comprise a plurality of main stage rails coupled to the main stage base and disposed parallel to each other with a transfer direction of the articulated robot as a length direction, and
the main stage rack is disposed between the plurality of main stage rails parallel to the plurality of main stage rails with the transfer direction of the articulated robot as a length direction.

17. A multi coupler connection device for connecting a supply-side coupler of a supply hose brought into an interior of any one of a plurality of door units corresponding to each of a plurality of storage units each storing different chemicals with a storage-side coupler of any one of the plurality of storage units, the device comprising:
an articulated robot that moves and connects the supply-side coupler with the storage-side coupler;
a main stage unit that transfers the articulated robot in a direction in which the plurality of storage units are disposed; and
a vision unit that determines whether the supply-side coupler should be connected to the storage-side coupler.
